(19) United States
(12) Patent Application Publication
(10) Pub. No.: US 2004/0025054 A1
(43) Pub. Date: Feb. 5, 2004

(54) MPLS/BGP VPN gateway-based networking method

(76) Inventor: Guofeng Xue, Shenzhen (CN)

Correspondence Address: Morgan & Finnegan L.L.P., Maria C.H. Lin, 345 Park Avenue, New York, NY, 10154-0053, US

(21) Appl. No.: 10/393,931

(22) Filed: Mar. 20, 2003

(30) Foreign Application Priority Data
Aug. 5, 2002 (CN) 02125817.1

(51) Int. Cl. H04L 9/00; G06F 15/16

(52) U.S. Cl. 713/201; 709/230

(57) ABSTRACT

The present invention discloses a MPLS/BGP VPN gateway-based network method comprising: interposing one or more Multi Protocol Label Switching Virtual Private Network (MPLS VPN) gateways between a first ISP network and a second ISP network, connecting the MPLS/BGP VPN gateway with the first ISP network and the second ISP network and at the same time connect the MPLS/BGP VPN gateway with a Custom Edge Router (CE) in the first ISP subscriber's network, and activating protocol transmissions on the MPLS/BGP VPN gateway to provide MPLS/BGP VPN services. The present invention enables ISPs to provide MPLS/BGP VPN services quickly with low investment and make use of conventional network without comprehensive reconstruction, which enhances competitive power and protect conventional investment.

### FIELD OF THE INVENTION

The present invention relates to a networking method, particularly to a Multi Protocol Label Switching Virtual Private Network gateway-based networking method using Border Gateway Protocols.

### BACKGROUND OF THE INVENTION

VPN (Virtual Private Network) is a way of using the shared public telecommunication infrastructure, such as the Internet, to provide users with secured private network service. A VPN maintains privacy through security procedures and tunneling protocols such as the L2TP (Layer Two Tunneling Protocol). Through a VPN, an enterprise or a specific user group can establish secure and reliable connections among to their branches, remote users, and business partners to transfer data at a low cost.

Previously, VPN is IP(Internet Protocol) based, i.e., IP VPN, which simulates a dedicated WAN (Wide Area Network) with IP network structure and is implemented through some IP tunnel mechanisms such as the L2TP. The IP VPN subscribers' data are transferred via tunnels. However, IP VPNs have configuration, manageability and scalability problems.

To solve these problems, some ISPs (Internet service provider) turned to MPLS/BGP VPN.

MPLS (Multiprotocol Label Switching) is a standard-approved technology for speeding up network traffic flow and making it easier to manage. MPLS involves setting up a specific path for a given sequence of packets, each of which is identified by a label, this means the time needed for a router to look up the address of the next node to forward the packet is reduced. MPLS technology provides a variety of benefits, including support for IP VPN services, traffic engineering, QoS (quality of service) improvement, Multi-Broadcast, route display and IP and ATM (Asynchronous Transport Mode) integration. MPLS is ideal for IP backbone networking.

BGP(Border Gateway Protocol) is a protocol for exchanging routing information between gateway hosts on the Internet.

MPLS/BGP VPN employs MPLS, BGP and VPN technologies, and enables ISP to provide MPLS/BGP VPN services to subscribers through public networks.

FIG. 1 shows a conventional MPLS/BGP VPN network structure, wherein an ISP's network comprises of Ps (Provider Routers) and PEs (Provider Edge Routers).

P is responsible for MPLS package forwarding within the ISP network. PE is responsible for providing MPLS/BGP VPN services to the VPN subscribers. PE maintains an independent route table for each subscriber's site, and detects VPN topologies and VPN internal routes through BGP. CE (Custom Edge Router) connects a subscriber's site to the PE directly. CE is an ordinary router which does not need to support MPLS or VPN signaling and protocol.

A subscriber of a VPN may have a plurality of sites, each of which may be a set of networks or sub-networks. The plurality of sites constitute a 3-layer interconnection structure through the ISP network, and the ISP network is responsible for routing and forwarding tasks among the sites.

However, MPLS/BGP VPN ISPs are facing the following problems. To provide MPLS/BGP VPN service, the ISP network is composed of Ps and PEs. However, most conventional ISP network employs diverse technologies, for example, router networking, ATM networking or Ethernet networking, which do not support MPLS. Plus, there is no corresponding P or PE in the network. To provide MPLS/BGP VPN services, conventional networks have to be upgraded and reconstructed comprehensively. This will not only bring adverse effect to conventional services, but will also require large amounts of investment to construct Ps and PEs in the networks. The above mentioned problems restraint the development and popularization of MPLS/BGP VPN services.

Therefore, there exists the need for a method which does not require comprehensive reconstructing of the conventional ISP networks, and at the same time be able to implement secured VPN over the public infrastructure with MPLS capabilities using BGP.

It is another object of the invention to make use of the conventional ISP network structure without comprehensive reconstruction, and reduce significantly the cost for secured transmissions.

It is another object of the invention to use a conventional ISP network as the data forwarding plane and add a network service plane to make full use of the ability to access of conventional ISP networks.

These and other objects of the invention will become apparent to those skilled in the art from the description as follows.

### SUMMARY OF THE INVENTION

The object of the present invention is to provide a MPLS/BGP VPN gateway-based networking method, with which an ISP can quickly deliver MPLS/BGP VPN services at minimum cost without modifying the structure of a conventional ISP network.

To attain this objective, the MPLS/BGP VPN networking method of the present invention comprises the following steps:

1. Interposing at least one MPLS/BGP VPN gateway between a first ISP network and a second ISP network;

2. Connecting the MPLS/BGP VPN gateway with the first ISP network and the second ISP network;

3. Connecting the MPLS/BGP VPN gateway with a CE in the subscriber's network; and

4. Activating protocol transmissions on the MPLS/BGP VPN gateway to provide MPLS/BGP VPN services.

In step 1, the number of MPLS/BGP VPN gateways to be interposed is in accordance with the amount of actual traffic of the MPLS/BGP VPN services.

In Step 2, the MPLS/BGP VPN gateway is connected to the first ISP network via IP, LAN (Local Area Network), VLAN (Virtual Local Area Network), or ATM PVC (Asynchronous Transfer Mode Permanent Virtual Connection).

In Step 2, the connection between said MPLS/BGP VPN gateway and the second ISP network supports both IP and MPLS protocols.

In one embodiment of Step 3, the network connections between said MPLS/BGP VPN gateway and the CE in the subscribers' network are through direct physical links.

In another embodiment of Step 3, the connection between said MPLS/BGP VPN gateway and CE in the subscribers' network can be implemented in accordance with the following method: connecting the CE to the first ISP network through physical links, and then connecting the CE to said MPLS/BGP VPN gateway through a layer 2 or a layer 3 connection via the first ISP network.

According to the method of the present invention, a service plane of MPLS/BGP VPN is built by setting MPLS/BGP VPN gateways on the basis of the first ISP networks, separating the network service plane from the data forwarding plane. In this way, the first ISP network can be dedicated to subscriber access and data forwarding; while newly appended gateways can be dedicated to provide MPLS/BGP VPN services. Thus ISPs can take full advantage of the ability to access of a conventional network to quickly deliver MPLS/BGP VPN services at a low cost without modifying conventional network structure, and to enhance competitive power and protect conventional investment.

### BRIEF DESCRIPTION OF THE DRAWINGS

FIG. 1 shows a conventional MPLS/BGP VPN ISP network structure;

FIG. 2 shows the network structure of the MPLS/BGP VPN constructed according to the method of the present invention;

FIG. 3 is the flow chart of the method according to the present invention.

### DETAILED DESCRIPTION OF THE EMBODIMENT

The present invention enables the formation of a VPN with MPLS capabilities using BGP through the public network without reconstructing a conventional ISP network.

The method of the present invention essentially use a conventional ISP network as the data forwarding plane and add a MPLS/BGP VPN gateway as a network service plane to make full use of the ability to access of the conventional ISP network.

The subscribers' network can be connected to a MPLS/BGP VPN gateway through a direct physical link, a layer two or a layer three connection. An MPLS/BGP VPN gateway is responsible for providing MPLS/BGP VPN services at a low cost without modifying a conventional ISP network structure.

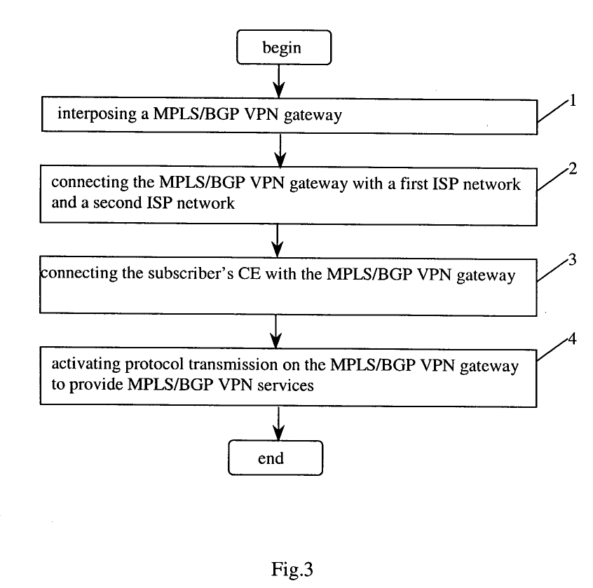

FIG. 3 shows the flow chart of the method according to the present invention.

According to step 1, at least one MPLS/BGP VPN gateway is interposed between a first ISP network and a second ISP network. The exact number of MPLS/BGP VPN gateways to be interposed is in accordance with the actual traffic of MPLS/BGP VPN services.

In step 2, the MPLS/BGP VPN gateway is connected to a first ISP network, and a second ISP network.

The connection between the first ISP network and the MPLS/BGP VPN gateway is set according to the structure of the first ISP network. For example: if the first ISP network employs an Ethernet for networking, a LAN/VLAN can be used; if the first ISP network employs an ATM for networking, an ATM PVC can be used; if the first ISP network employs routers in networking, an IP can be used.

If MPLS/BGP VPN service is to be provided across the first ISP network, the connection between the first ISP network and the MPLS/BGP VPN gateway has to be established, and the connection should support both IP and MPLS capabilities at the same time.

The MPLS/BGP VPN gateway is connected to the second ISP network through a device in the second ISP network which supports MPLS and MPLS/BGP VPN. The device in the second ISP network can be a PE.

In step 3, the MPLS/BGP VPN gateway is connected to a CE in the subscriber network.

The CE can be connected to the MPLS/BGP VPN gateway through direct physical links, such as Ethernet, Digital Data Network (DDN), ATM, etc. . . .

The CE can also first be connected to the first ISP network through direct physical links, and then connected to the MPLS/BGP VPN gateway using the ability to access of the first ISP network. The ability to access enables a layer two connection (Data Link Layer) where the subscribers' CE can be connected to the MPLS/BGP VPN gateway via ATM PVCs, LAN/VLAN in ATM or LANSWITCH networks. The ability to access can also enable a layer three connection (Network Layer) where the subscribers' CE can be connected to the MPLS/BGP VPN gateway with tunnel technologies such as IP GRE (Generic Routing Encapsulation), IPSEC (Internet Protocol Security), or L2TP.

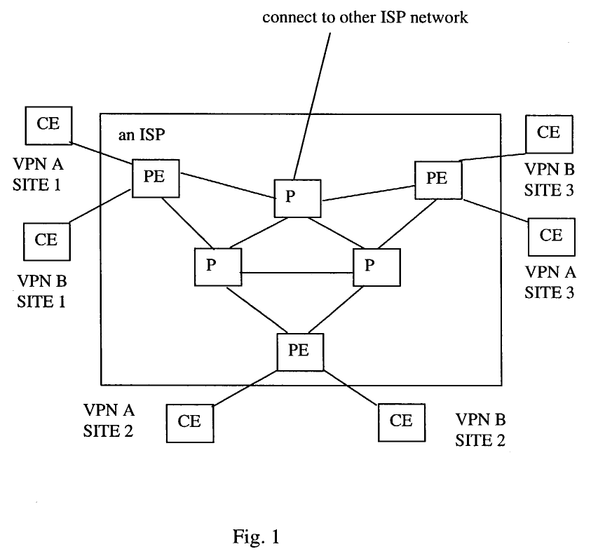

In step 4, protocol transmission between the first ISP and the second ISP on the MPLS/BGP VPN gateway are activated to provide MPLS/BGP VPN services. To a MPLS/BGP VPN gateway, all access methods are identical to direct physical link connections. When,a subscriber's CE accesses the MPLS/BGP VPN gateway through various methods, protocol transmission is activated, the gateway is configured similarly to a PE. When MPLS/BGP VPN services are provided across a plurality of ISP networks, the relationship between the MPLS/BGP VPN gateway and the devices in the plurality of ISPs connected to the MPLS/BGP VPN gateway is identical to the “P-PE” relationship in the conventional MPLS/BGP VPN networking structure as shown in FIG. 1.

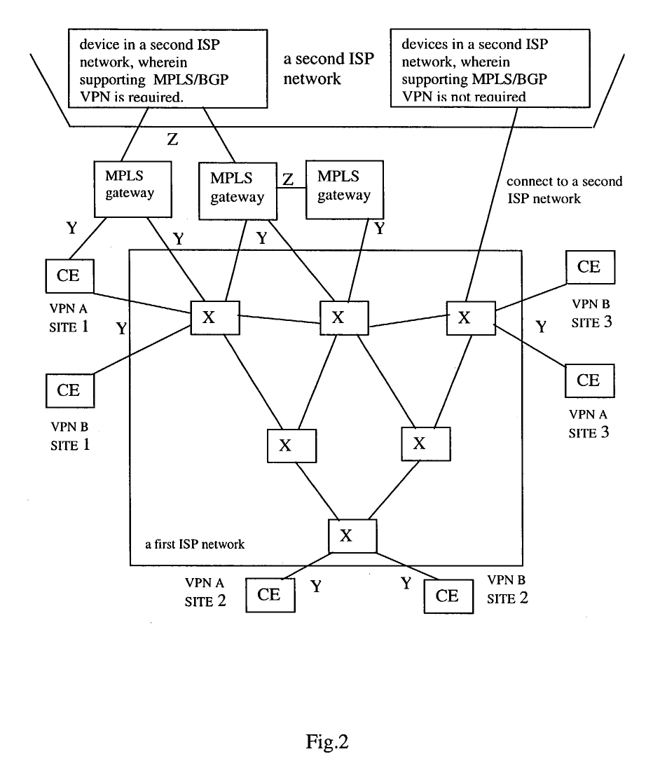

FIG. 2 illustrates a network structure constructed according to the method in the present invention. The MPLS/BGP VPN gateway can be a standard PE, which has rich access property to access a CE through various methods; the MPLS/BGP VPN gateways constitute a service plane of the network and are responsible for delivering MPLS/BGP VPN services.

In FIG. 2, X represents a router, such as an Ethernet switch or an ATM device, which does not need to support MPLS or MPLS/BGP VPN signaling or protocol. The MPLS/BGP VPN gateway-based method has no technical requirement for the first network structure, which can be router networking, ATM switch networking, Ethernet switch networking, etc. The Xs constitute the data forwarding plane of the first ISP network and are responsible for subscriber access and data forwarding.

Y represents a connection among CE, X and the MPLS/BGP VPN gateway, or a connection between X and the MPLS/BGP VPN gateway. Y may be various connections, including IP, LAN/VLAN, or ATM PVC.

Z represents a connection between the MPLS/BGP VPN gateway and a device in the second ISP network, the device in the second ISP network supports MPLS and MPLS/BGP VPN signaling and protocols. Z also represents a connection between each of the MPLS/BGP VPN gateways. The connection Z supports both IP and MPLS.

In FIG. 2, CE may be connected to the MPLS/BGP VPN gateway through various methods, such as direct physical links, layer two or layer three connections. The plurality of MPLS/BGPVPN gateways is responsible for providing MPLS/BGP VPN services and providing MPLS/BGP VPN traffic ability.

In order to provide MPLS/BGP VPN services across a plurality of ISP networks, the MPLS/BGP VPN gateway of the first ISP network has to be connected to a device in each of a plurality of ISP networks. The plurality of ISP networks support MPLS and MPLS/BGP VPN signaling and protocols. Each device in the plurality of ISP networks can be a PE. When MPLS/BGP VPN services are provided across a plurality of ISP networks, the relationship between the MPLS/BGP VPN gateway of the first ISP network and the devices in the plurality of ISP networks corresponds to the PE-P relationship in the conventional MPLS/BGP VPN networking structure as shown in FIG. 1.

When MPLS/BGP VPN traffic increases, more MPLS/BGP VPN gateways can be added either through independent deployment or dependent deployment. In independent deployment, each newly added MPLS/BGP VPN gateway is connected to a device in the second or the plurality of ISP networks through the connection Z independently, and each MPLS/BGP VPN gateway is connected to the first ISP network through the connection Y. In dependent deployment, newly added MPLS/BGP VPN gateway can be connected to other existing MPLS/BGP VPN gateways via the connection Z, and each MPLS/BGP VPN gateway is connected to the first ISP network through the connection Y.

What is claimed is:

1. A MPLS/BGP VPN gateway-based networking method enabling private communications between subscribers of a first ISP network and subscribers of a second ISP network, comprising the steps:
i) interposing at least one MPLS/BGP VPN gateway between the first ISP network and the second ISP network to construct a virtual private network (VPN) with Multiprotocol Label Switching (MPLS) capabilities using Border Gateway Protocol (BGP) wherein the MPLS/BGP VPN gateway provides MPLS/BGP VPN services;
ii) connecting the MPLS/BGP VPN gateway with the first ISP network and the second ISP network;
iii) connecting the MPLS/BGP VPN gateway to a CE in the subscriber's network;
iv) activating protocol transmissions on the MPLS/BGP VPN gateway to provide MPLS/BGP VPN services.

2. A MPLS/BGP VPN gateway-based networking method, wherein the number of MPLS/BGP VPN gateways to be interposed according to claim 1 is in accordance with the amount of actual traffic of the MPLS/BGP VPN services.

3. A MPLS/BGP VPN gateway-based networking method according to claim 1, wherein the MPLS/BGP VPN gateway and the first ISP network are connected through IP, Local Area Network (LAN), Virtual Local Area Network (VLAN), Asynchronous Transfer Mode Permanent Virtual Connection (ATM PVC).

4. A MPLS/BGP VPN gateway-based networking method according to claim 3, wherein the connection between the MPLS/BGP VPN gateway and the second ISP network supports both IP and MPLS protocols.

5. A MPLS/BGP VPN gateway-based networking method according to claim 1, wherein the MPLS/BGP VPN gateway is connected through direct physical link to a Customer Edge Router (CE) in the subscriber's network.

6. A MPLS/BGP VPN gateway-based networking method of claim 1, wherein CE is connected to the first ISP network by a direct physical link, and the first ISP network is connected to the MPLS/BGP VPN gateway.

7. A MPLS/BGP VPN gateway-based networking method according to claim 6, wherein the first ISP network is connected to the MPLS/BGP VPN gateway through a layer two connection implemented by the first ISP network.

8. A MPLS/BGP VPN gateway-based networking method according to claim 6, wherein the first ISP network is connected to the MPLS/BGP VPN gateway through a layer three connection implemented by the first ISP network.
